(19) United States
(12) Patent Application Publication
(10) Pub. No.: US 2026/0229825 A1
(43) Pub. Date: Aug. 6, 2026

(54) CONNECTOR AND WIRING HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shuya NISHIO, Mie (JP); Naoki ISHIDA, Mie (JP)

(21) Appl. No.: 19/147,716

(22) PCT Filed: Jan. 19, 2024
(86) PCT No.: PCT/JP2024/001406

§ 371 Date: Jul. 14, 2025

(30) Foreign Application Priority Data
Jan. 30, 2023 (JP) 2023-012049

(51) Int. Cl. H01R 13/6592; B60R 16/02; H01R 13/02; H01R 13/506; H01R 13/58; H01R 13/6581

(52) U.S. Cl. CPC H01R 13/6592; B60R 16/0207; H01R 13/025; H01R 13/506; H01R 13/5804; H01R 13/6581; H01R 2201/26

(57) ABSTRACT

The present disclosure provides a connector and a wire harness which are capable of suppressing reduction in electromagnetic shielding ability. A connector (30) according to one aspect of the present disclosure comprises: a terminal (31) that is electrically conductive and is connected to an end of a core wire (21) of a shield wire (20); and a shield sleeve (70) that is electrically conductive and is attached to the outer circumference of the shield wire (20) in a state of being in contact with the outer circumference of an electromagnetic shield member (23) of the shield wire (20). The connector (30) comprises a shield shell (50) that is electrically conductive and that covers the terminal (31) and the shield sleeve (70). The shield shell (50) has a through-hole (61) through which the shield wire (20) passes. The shield sleeve (70) has a pressure-fitting portion (72) pressure-fitted to the the through-hole (61) along a pressure-fitting direction (D1) extending in parallel with the axial direction of the through-hole (61). The pressure-fitting portion (72) is in contact with the shield shell (50) in a state of being pressure-fitted.

### TECHNICAL FIELD

The present disclosure relates to a connector and a wiring harness.

### BACKGROUND

Conventionally, a wiring harness provided with a shielded wire and a connector mounted on an end part of the shielded wire is known as a wiring harness to be routed inside a vehicle such as a hybrid vehicle or an electric vehicle (see, for example, Patent Document 1). The shielded wire includes an electrically conductive core wire, an insulation coating surrounding the outer periphery of the core wire, an electromagnetic shield member surrounding the outer periphery of the insulation coating and a sheath surrounding the outer periphery of the electromagnetic shield member. In the shielded wire of this type, an end in an axial direction of the electromagnetic shield member is exposed from the sheath. An annular shield sleeve made of metal is mounted on the outer periphery of a part of the electromagnetic shield member exposed from the sheath. The electromagnetic shield member and the shield sleeve are electrically connected by contacting each other. Further, the shield sleeve is connected to the inner peripheral surface of a metal-made shield shell of a connector by a spring. The shield sleeve and the shield shell are electrically connected by contacting each other by the spring.

### PRIOR ART DOCUMENT

### Patent Document

Patent Document 1: JP 2022-155937 A

### SUMMARY OF THE INVENTION

### Problems to be Solved

If the shielded wire becomes thicker as a larger current flows in the shielded wire, the shielded wire largely moves (e.g. swings) when the shielded wire vibrates due to vehicle travel or the like. Then, the swing of the shielded wire is transmitted to a contact part of the shield sleeve and the shield shell and the contact part of the shield sleeve and the shield shell is easily worn. If the contact part of the shield sleeve and the shield shell is further worn, there is a problem of reducing electromagnetic shielding performance.

The present disclosure aims to provide a connector and a wiring harness capable of suppressing a reduction in electromagnetic shielding performance.

### Means to Solve the Problem

The present disclosure is directed to a connector to be connected to an end part of a shielded wire including an electrically conductive core wire, an insulation coating surrounding an outer periphery of the core wire and an electrically conductive electromagnetic shield member surrounding an outer periphery of the insulation coating, the connector being provided with an electrically conductive terminal to be connected to the core wire, an electrically conductive shield sleeve to be mounted on an outer periphery of the shielded wire while being held in contact with an outer periphery of the electromagnetic shield member, and an electrically conductive shield shell for covering the terminal and the shield shell, the shield shell including a through hole, the shielded wire being passed through the through hole, the shield sleeve including a press-fit portion to be press-fit into the through hole along a press-fitting direction extending parallel to an axial direction of the through hole, and the press-fit portion being press-fit in contact with the shield shell.

### Effect of the Invention

According to the connector and a wiring harness of the present disclosure, an effect of suppressing a reduction in electromagnetic shielding performance is achieved.

### BRIEF DESCRIPTION OF THE DRAWINGS

FIG. 1 is a schematic perspective view showing a wiring harness of one embodiment.

FIG. 2 is a schematic exploded perspective view showing the wiring harness of the embodiment.

FIG. 3 is a schematic section (section along 3-3 in FIG. 4) showing the wiring harness of the embodiment.

FIG. 4 is a schematic section (section along 4-4 in FIG. 3) showing the wiring harness of the embodiment.

FIG. 5 is a schematic exploded perspective view showing a part of a connector of the embodiment.

FIG. 6 is a schematic exploded perspective view showing a part of the connector of the embodiment.

FIG. 7 is a schematic section (section along 7-7 in FIG. 4) showing the wiring harness of the embodiment.

FIG. 8 is a schematic exploded perspective view showing a part of the connector of the embodiment.

FIG. 9 is a schematic section showing a manufacturing method of the wiring harness of the embodiment.

FIG. 10 is a schematic section showing the manufacturing method of the wiring harness of the embodiment.

FIG. 11 is a schematic section showing the manufacturing method of the wiring harness of the embodiment.

### DETAILED DESCRIPTION TO EXECUTE THE INVENTION

### Description of Embodiments of Present Disclosure

First, embodiments of the present disclosure are listed and described.
[1] The connector of the present disclosure is to be connected to an end part of a shielded wire including an electrically conductive core wire, an insulation coating surrounding an outer periphery of the core wire and an electrically conductive electromagnetic shield member surrounding an outer periphery of the insulation coating, and provided with an electrically conductive terminal to be connected to the core wire, an electrically conductive shield sleeve to be mounted on an outer periphery of the shielded wire while being held in contact with an outer periphery of the electromagnetic shield member, and an electrically conductive shield shell for covering the terminal and the shield shell, the shield shell including a through hole, the shielded wire being passed through the through hole, the shield sleeve including a press-fit portion to be press-fit into the through hole along a press-fitting direction extending parallel to an axial direction of the through hole, and the press-fit portion being press-fit in contact with the shield shell.

According to this configuration, the shield sleeve is held in contact with the outer periphery of the electromagnetic shield member and the press-fit portion of the shield sleeve is press-fit in contact with the shield shell. In this way, the shield sleeve and the electromagnetic shield member are electrically connected to each other, and the shield sleeve and the shield shell are electrically connected to each other. Further, since a connected part of the shield sleeve and the shield shell can have a press-fit structure, the shield sleeve and the shield shell can be firmly connected as compared to the case where the shield sleeve and the shield shell are connected by a spring. In this way, the shield sleeve can be firmly held in the shield shell and the shielded wire can be firmly held in the shield shell. Thus, even if the shielded wire vibrates due to vehicle travel or the like, a movement (e.g. swing) of the shielded wire can be suitably restricted in the connected part of the shield sleeve and the shield shell. As a result, the wear of the connected part of the shield sleeve and the shield shell can be suppressed and a reduction in electromagnetic shielding performance can be suppressed.
[2] In [1] described above, an outer peripheral surface of the press-fit portion may have a first inclined surface inclined radially inwardly of the through hole from an upstream side in the press-fitting direction toward a downstream side in the press-fitting direction.

According to this configuration, since the first inclined surface is provided on the outer peripheral surface of the press-fit portion, the press-fit portion is so formed that an outer peripheral dimension becomes smaller from the upstream side in the press-fitting direction toward the downstream side in the press-fitting direction. Thus, the press-fit portion has various outer peripheral dimensions. Therefore, dimensional tolerances of the shield sleeve and the shield shell can be suitably absorbed by the first inclined surface. In this way, even if the dimensional tolerances of the shield sleeve and the shield shell are large, the press-fit portion can be suitably press-fit into the through hole.
[3] In [1] or [2] described above, a plurality of projecting portions projecting radially inwardly of the through hole may be provided on an inner peripheral surface of the through hole, the plurality of projecting portions may be provided at intervals along a circumferential direction of the through hole, and the press-fit portion may be press-fit in contact with a tip surface of each of the plurality of projecting portions.

According to this configuration, the plurality of projecting portions to be brought into contact with the press-fit portion of the shield sleeve in a press-fit state are provided at intervals along the circumferential direction of the through hole. In other words, there are regions, where wall portions, i.e. the projecting portions, to be brought into contact with the press-fit portion in the press-fit state are not provided, in circumferential parts of the through hole on the inner peripheral surface of the through hole. By providing such regions, even if the press-fit portion is deformed when being press-fit into the through hole, the deformation of the press-fit portion can be suitably released to the above regions. Since the deformation of the press-fit portion can be allowed during press-fitting in this way, the assemblability of the shield sleeve and the shield shell in press-fitting the press-fit portion into the through hole can be improved.
[4] In [3] described above, each of the plurality of projecting portions may extend along the press-fitting direction, and the tip surface may have a second inclined surface inclined radially inwardly of the through hole from an upstream side in the press-fitting direction toward a downstream side in the press-fitting direction.

According to this configuration, the second inclined surface is provided on the tip surface of each projecting portion. Thus, a space provided inside the plurality of projecting portions, out of the through hole, is formed to become smaller from the upstream side in the press-fitting direction toward the downstream side in the press-fitting direction. In this way, the dimensional tolerances of the shield sleeve and the shield shell can be suitably absorbed by the second inclined surfaces. Therefore, even if the dimensional tolerances of the shield sleeve and the shield shell are large, the press-fit portion can be suitably press-fit into the through hole.
[5] In [4] described above, the tip surface may have a guiding surface for guiding the shield sleeve to the downstream side in the press-fitting direction, the guiding surface may be inclined radially inwardly of the through hole from the upstream side in the press-fitting direction toward the downstream side in the press-fitting direction, and the guiding surface may be inclined more than the second inclined surface with respect to the press-fitting direction.

According to this configuration, the guiding surface inclined more radially inwardly of the through hole than the second inclined surface from the upstream side in the press-fitting direction toward the downstream side in the press-fitting direction is provided on the tip surface of the projecting portion. According to this configuration, when the press-fit portion is press-fit into the through hole, the press-fit portion is guided to the downstream side in the press-fitting direction along the guiding surfaces of the projecting portions. In this way, workability in press-fitting the press-fit portion into the through hole can be improved.
[6] In any one of [3] to [5] described above, the tip surface may be formed to have a round cross-sectional shape obtained by cutting the projecting portion by a plane perpendicular to the press-fitting direction.

According to this configuration, since the tip surfaces of the projecting portions are formed to have a round shape, the shield sleeve is less likely to be damaged, for example, as compared to the case where the tip surfaces of the projecting portions have an angular shape.
[7] In any one of [1] to [6] described above, the press-fit portion may be in the form of a rectangular tube, and the through hole may be formed to have a rectangular planar shape when viewed from the press-fitting direction.

According to this configuration, if the press-fit portion is press-fit into the through hole, the relative rotation of the press-fit portion about an axis extending in the press-fitting direction with respect to the through hole can be suitably suppressed. In this way, the relative rotation of the shielded wire about the axis extending in the press-fitting direction with respect to the through hole can be suppressed.
[8] In any one of [1] to [7] described above, the shield sleeve may include the press-fit portion and a wire connecting portion continuously and integrally formed with the press-fit portion and to be connected to the electromagnetic shield member, and an outer peripheral dimension of the press-fit portion may be larger than that of the wire connecting portion.

According to this configuration, the outer peripheral dimension of the press-fit portion to be press-fit into the through hole is larger than that of the wire connecting portion to be connected to the outer periphery of the electromagnetic shield member. In this way, even if the press-fit portion is deformed by being press-fit into the through hole, the damage of the electromagnetic shield member due to that deformation of the press-fit portion can be suitably suppressed.
[9] In any one of [1] to [8] described above, the shield shell may be made of aluminum die cast.

According to this configuration, the electrically conductive shield shell can be easily manufactured.
[10] A wiring harness of the present disclosure is provided with the connector of any one of [1] to [9] described above, and the shielded wire to be connected to the terminal.

According to this configuration, effects similar to those of the connector of [1] described above can be obtained.

### Details of Embodiment of Present Disclosure

Specific examples of a connector and a wiring harness of the present disclosure are described below with reference to the drawings. For the convenience of description, some components may be shown in an exaggerated or simplified manner in each drawing. Further, a dimension ratio of each part may be different in each figure. Further, “parallel”, “orthogonal” and “horizontal” in this specification mean not only strictly parallel, orthogonal and horizontal, but also substantially parallel, orthogonal and horizontal within a range in which functions and effects in this embodiment are achieved. A term “tubular” used in the description of this specification indicates not only a shape formed by a peripheral wall continuous over an entire periphery in a circumferential direction, but also a shape formed by combining a plurality of components and a shape having a cut or the like in a circumferential part such as a C shape. Note that “tubular” shapes include circular shapes, elliptical shapes and polygonal shapes with angular or round corners, but there is no limitation to these. “Facing each other” in this specification indicates that surfaces or members are at positions in front of each other, and means not only a case where the surfaces or members are at positions perfectly in front of each other, but also a case where the surfaces or members are partially in front of each other. Further, “facing each other” in this specification means both a case where another member different from two parts is interposed between the two parts and a case where nothing is interposed between the two part. Further, an inner peripheral dimension of a member A″ in this specification means a one-round length of the inner peripheral surface of the member A along a circumferential direction of the member A. Further, an outer peripheral dimension of the member A″ in this specification means a one-round length of the outer peripheral surface of the member A along the circumferential direction of the member A. Terms such as “first”, “second” and “third” in this specification are merely used to distinguish objects and do not rank the objects. Note that the present invention is not limited to these illustrations, but is represented by claims and intended to include all changes in the scope of claims and in the meaning and scope of equivalents.

### Overall Configuration of Wiring Harness 10

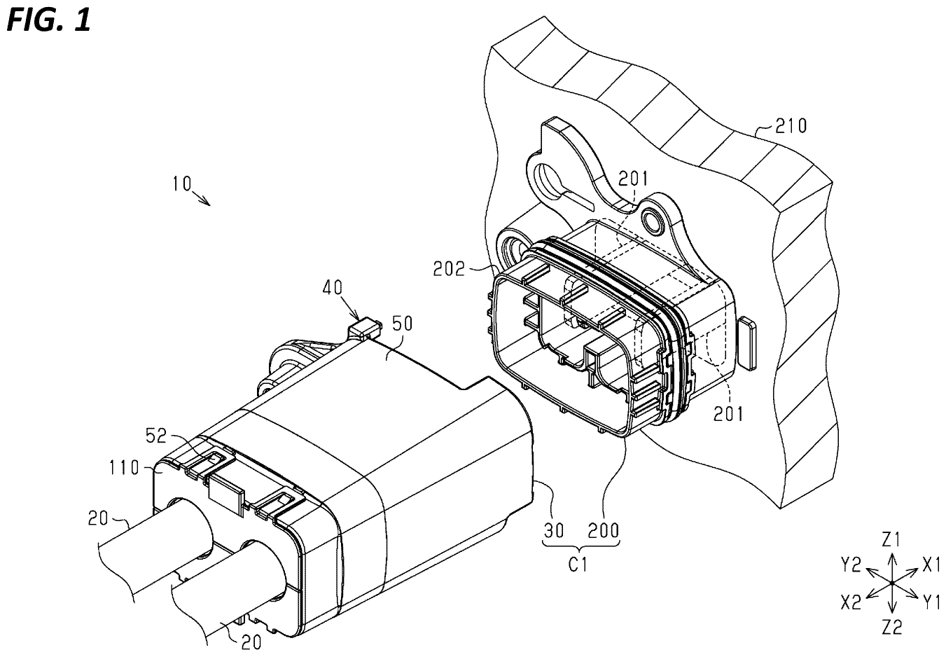

As shown in FIG. 1, a wiring harness 10 is provided with one or more (two in this embodiment) shielded wires 20 and a connector assembly C1 mounted on end parts of the shielded wires 20. The wiring harness 10 is, for example, provided in a vehicle such as a hybrid vehicle or an electric vehicle. The wiring harness 10 is, for example, for electrically connecting electrical devices for vehicle. A high-voltage battery, an inverter, a motor and a relay box can be, for example, cited as the electrical devices. The connector assembly C1 is, for example, provided on one electrical device.

### Overall Configuration of Connector Assembly C1

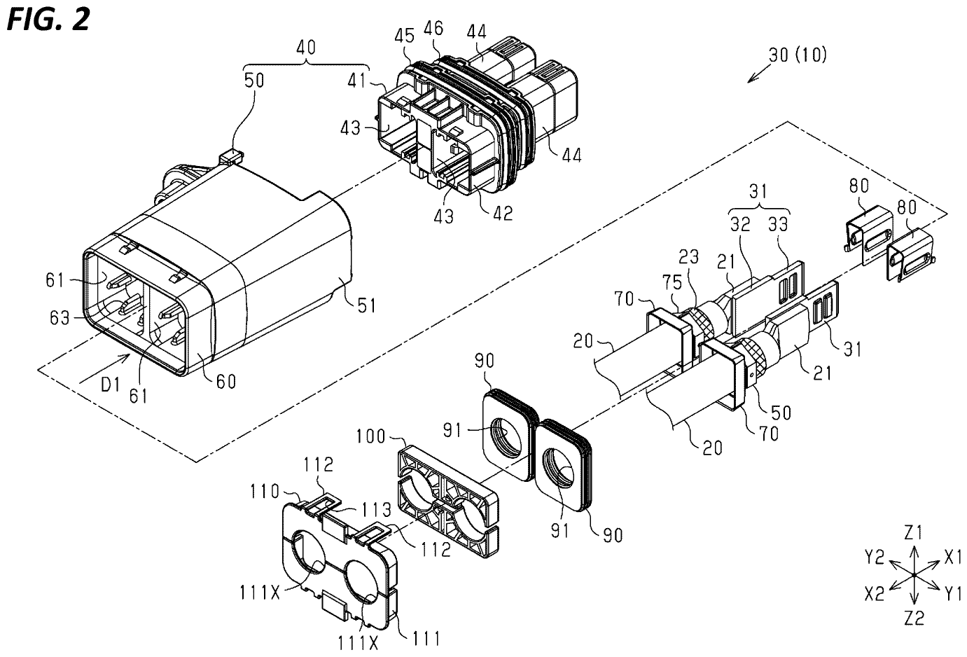

The connector assembly C1 includes a connector 30 and a connector 200 attachable to and detachable from the connector 30. The connector 200 is, for example, fixed to a mounting target such as a case 210 of the electrical device. The connector 200 includes a plurality of (two in this embodiment) terminals 201 made of metal and a connector housing 202 for holding the plurality of terminals 201. The connectors 30 and 200 are assembled with each other along a first direction X1. The connector 30 is, for example, connected to the connector 200 along the first direction X1. If the connector 30 is properly connected to the connector 200, metal-made terminals 31 (see FIG. 2) of the connector 30 and the terminals 201 of the connector 200 are electrically connected to each other. Note that a vertical direction and a lateral direction in each figure do not necessarily indicate the postures of the connectors 30, 200 during use.

In the following description, an opposite direction of the first direction X1 is referred to as a first opposite direction X2 in describing a positional relationship of each constituent element of the connector 30. Further, out of directions orthogonal to the first direction X1, a rightward direction in FIG. 1 is referred to as a second direction Y1 and an opposite direction of the second direction Y1 is referred to as a second opposite direction Y2. Out of directions orthogonal to both the first and second directions X1, Y1, an upward direction in FIG. 1 is referred to as a third direction Z1 and an opposite direction of the third direction Z1 is referred to as a third opposite direction Z2.

### Configuration of Connector 30

As shown in FIG. 2, the connector 30 includes a plurality of the terminals 31 respectively connected to end parts of the plurality of shielded wires 20 and a tubular connector housing 40 for accommodating the plurality of terminals 31. The connector housing 40 includes an inner housing 41 for accommodating the terminals 31 and a shield shell 50 for covering the inner housing 41. The connector 30 includes one or more (two in this embodiment) electrically conductive shield sleeves 70 to be respectively mounted on the plurality of shielded wires 20 and one or more electrically conductive leaf springs 80. The connector 30 includes, for example, one or more (two in this embodiment) sealing members 90 to be fit inside the shield shell 50, a restricting member 100 for restricting movements of the shielded wires 20 and a retainer 110 for retaining the sealing members 90.

### Configuration of Shielded Wires 20

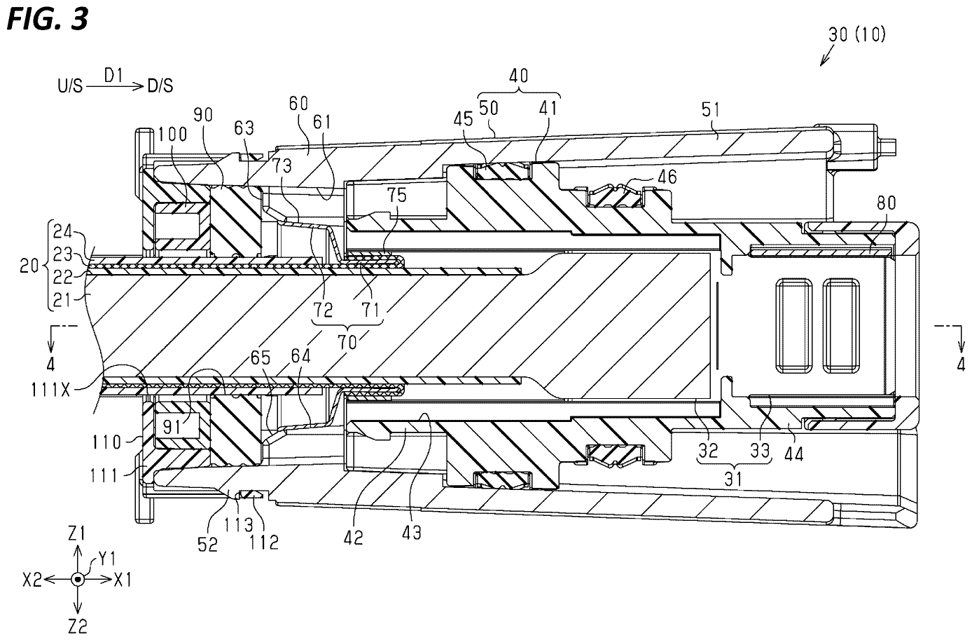

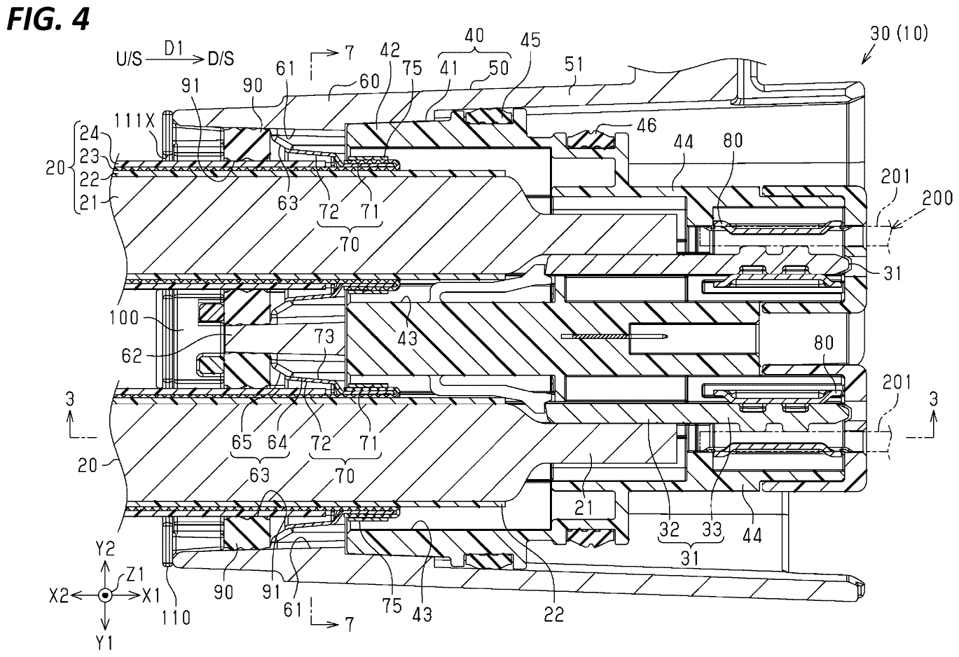

As shown in FIGS. 3 and 4, each shielded wire 20 includes an electrically conductive core wire and an insulating insulation coating 22 surrounding the outer periphery of the core wire 21. Each shielded wire 20 includes an electrically conductive electromagnetic shield member 23 surrounding the outer periphery of the insulation coating 22 and an insulating sheath 24 surrounding the outer periphery of the electromagnetic shield member 23. As just described, each shielded wire 20 has an electromagnetic shielding structure in itself.

A stranded wire formed by twisting a plurality of metal strands or a single core wire constituted by a single conductor can be, for example, used as the core wire 21. A columnar conductor made of one columnar metal bar having a solid structure inside and a tubular conductor having a hollow structure inside can be, for example, used as the single core wire. Further, a stranded wire, a columnar conductor and a tubular conductor may be used in combination as the core wire 21. A copper-based or aluminum-based metal material can be, for example, used as a material of the core wire 21.

The insulation coating 22 covers, for example, the outer peripheral surface of the core wire 21 over the entire periphery in a circumferential direction. The insulation coating 22 is, for example, made of an insulating resin material.

The electromagnetic shield member 23 surrounds, for example, the outer peripheral surface of the insulation coating 22 over the entire periphery in the circumferential direction. The electromagnetic shield member 23 is, for example, flexible. A braided wire formed by braiding a plurality of metal strands into a tubular shape and a metal foil can be, for example, used as the electromagnetic shield member 23. The electromagnetic shield member 23 of this embodiment is a braided wire. A copper-based or aluminum-based metal material can be, for example, used as a material of the

### Electromagnetic Shield Member 23

The sheath 24 surrounds, for example, the outer peripheral surface of the electromagnetic shield member 23 over the entire periphery in the circumferential direction. The sheath 24 is, for example, made of an insulating resin material.

A cross-sectional shape obtained by cutting the shielded wire 20 by a plane orthogonal to a length direction of the shielded wire 20, i.e. a transverse cross-sectional shape of the shielded wire 20, can be an arbitrary shape. The transverse cross-sectional shape of the shielded wire 20 can be, for example, a circular shape, a semicircular shape, a polygonal shape or a flat shape. The transverse cross-sectional shape of the shielded wire 20 of this embodiment is a circular shape.

As shown in FIG. 4, each shielded wire 20 extends along the first direction X1. In other words, an axial direction of each shielded wire 20 extends parallel to the first direction X1. The plurality of shielded wires 20 are, for example, arranged along the second direction Y1.

An end part in an axial direction (here, the first direction X1) of the core wire 21 is exposed from the insulation coating 22. The terminal 31 is connected to the end part of the core wire 21 exposed from the insulation coating 22. An end part in an axial direction (here, the first direction X1) of the electromagnetic shield member 23 is exposed from the sheath 24. The shield sleeve 70 is connected to the end part of the electromagnetic shield member 23 exposed from the sheath 24.

### Configuration of Terminals 31

The two terminals 31 are respectively electrically connected to the two shielded wires 20. Each terminal 31 includes, for example, a wire connecting portion 32 to be connected to the end part of the shielded wire 20 and a terminal connecting portion 33. Each terminal 31 is, for example, a single component in which the wire connecting portion 32 and the terminal connecting portion 33 are continuously and integrally formed. A metal material such as copper, copper alloy, aluminum, aluminum alloy or stainless steel can be, for example, used as a material of each terminal 31.

The wire connecting portion 32 is connected to the end part of the core wire 21 exposed from the insulation coating 22. The wire connecting portion 32 is, for example, in the form of a flat plate. The wire connecting portion 32 is, for example, connected to the core wire 21 by crimping or ultrasonic welding. In this way, the wire connecting portion 32 and the core wire 21 are electrically and mechanically connected.

The terminal connecting portion 33 is, for example, in the form of a flat plate. The terminal connecting portion 33 is electrically and mechanically connected to the terminal 201 of the connector 200.

### Configuration of Shield Sleeves 70

The two shield sleeves 70 are respectively mounted on the two shielded wires 20. Each shield sleeve 70 is mounted on the outer periphery of the end part of the electromagnetic shield member 23 exposed from the sheath 24. Each shield sleeve 70 is formed into a tubular shape. Each shield sleeve 70 is, for example, made of metal. A copper-based or aluminum-based metal material can be, for example, used as a material of each shield sleeve 70.

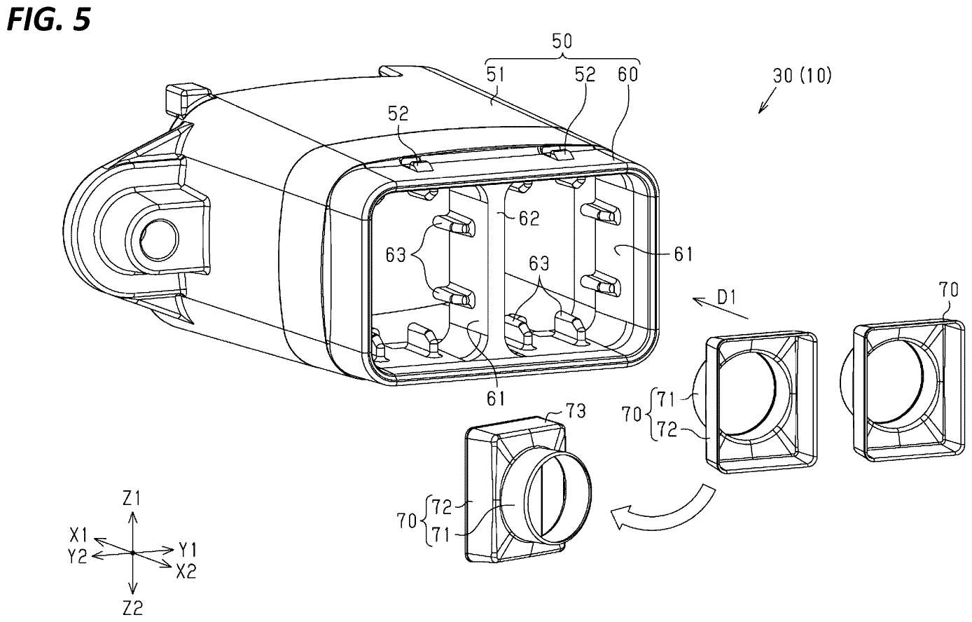

As shown in FIGS. 4 and 5, each shield sleeve 70 includes a wire connecting portion 71 and a press-fit portion 72. Each shield sleeve 70 is a single component in which the wire connecting portion 71 and the press-fit portion 72 are continuously and integrally formed.

The wire connecting portion 71 is, for example, provided on an end part in the first direction X1 of the shield sleeve 70. The wire connecting portion 71 is formed into a tubular shape along the outer peripheral surface of the shielded wire 20. As shown in FIG. 5, the wire connecting portion 71 of this embodiment is formed into a hollow cylindrical shape. Note that, out of the connector 30, only the shield shell 50 and the shield sleeves 70 are shown in a disassembled state in FIG. 5.

As shown in FIG. 3, the inner peripheral surface of the wire connecting portion 71 is in contact with the outer peripheral surface of the electromagnetic shield member 23 exposed from the sheath 24. The wire connecting portion 71 is, for example, connected to the outer peripheral surface of the electromagnetic shield member 23 by a fixing member 75. The fixing member 75 fixes the shield sleeve 70 to the outer peripheral surface of the shielded wire 20 with the inner peripheral surface of the wire connecting portion 71 held in contact with the electromagnetic shield member 23. The fixing member 75 is formed into an annular shape along the outer peripheral surface of the shielded wire 20. The fixing member 75 is fit to the outer side of the shield sleeve 70 while sandwiching the wire connecting portion 71 between the outer peripheral surface of the electromagnetic shield member 23 and the fixing member 75. Here, an end part in the axial direction of the electromagnetic shield member 23 is folded in the first opposite direction X2 to cover the outer periphery of the wire connecting portion 71. The fixing member 75 is, for example, fit to the outer side of the electromagnetic shield member 23 folded to cover the outer periphery of the wire connecting portion 71. The fixing member 75 is fastened radially inwardly of the shielded wire 20, whereby the wire connecting portion 71 of the shield sleeve 70 is crimped and fixed in a state directly in contact with the outer peripheral surface of the electromagnetic shield member 23. In this way, the electromagnetic shield member 23 and the shield sleeve 70 are electrically and mechanically connected to each other. A crimp ring and a crimp band can be, for example, used as the fixing member 75.

The press-fit portion 72 is, for example, provided on an end part in the first opposite direction X2 of the shield sleeve 70. The press-fit portion 72 is, for example, formed to protrude radially outwardly of the shield sleeve 70 from the outer peripheral surface of the wire connecting portion 71. As shown in FIG. 5, the press-fit portion 72 projects, for example, radially outward from the outer peripheral surface of the wire connecting portion 71 over the entire periphery of the wire connecting portion 71 in the circumferential direction. The press-fit portion 72 is formed into a tubular shape corresponding to the inner peripheral surface of the shield shell 50. The press-fit portion 72 of this embodiment is in the form of a rectangular tube. A transverse cross-sectional shape along the outer peripheral surface of the press-fit portion 72 is a rectangular shape. A transverse cross-sectional shape along the inner peripheral surface of the press-fit portion 72 is a rectangular shape.

An outer peripheral dimension of the press-fit portion 72 is, for example, larger than that of the wire connecting portion 71. An inner peripheral dimension of the press-fit portion 72 is, for example, larger than that of the wire connecting portion 71. The press-fit portion 72 is press-fit into the shield shell 50. The press-fit portion 72 is, for example, press-fit into the shield shell 50 along a press-fitting direction D1 extending parallel to the axial direction of the shield shell 50. The press-fit portion 72 is inserted into the shield shell 50 with the outer peripheral surface of the press-fit portion 72 held in contact with the inner peripheral surface of the shield shell 50. Here, the press-fitting direction D1 of this embodiment coincides with the first direction X1. In this specification, in the press-fitting direction D1, the side of the first opposite direction X1 where the press-fitting of the shield sleeve 70 is started is referred to as an “upstream side” and the side of the first direction X1 is referred to as a “downstream side”. That is, a front side in the press-fitting direction D1 is referred to as the upstream side and a back side in the press-fitting direction D1 is referred to as the downstream side.

As shown in FIG. 3, the outer peripheral surface of the press-fit portion 72 has a first inclined surface 73 inclined radially inwardly of the shield sleeve 70 from the upstream side in the press-fitting direction D1 toward the downstream side in the press-fitting direction D1. The first inclined surface 73 is, for example, inclined radially inwardly of the shield sleeve 70 from the end part in the first opposite direction X2 of the shield sleeve 70 toward the wire connecting portion 71. The first inclined surface 73 is, for example, formed over the entire length in an axial direction (here, the first direction X1) of the press-fit portion 72. The first inclined surface 73 is, for example, formed over the entire periphery of the press-fit portion 72 in the circumferential direction. The outer peripheral dimension of the press-fit portion 72 becomes smaller from the end part in the first opposite direction X2 toward the wire connecting portion 71.

### Configuration of Leaf Springs 80

As shown in FIG. 2, two leaf springs 80 are provided to respectively correspond to the two shielded wires 20. An iron-based or copper-based metal material can be, for example, used as a material of each leaf spring 80. Each leaf spring 80 is formed into a U shape in a plan view when viewed from the first direction X1.

### Configuration of Inner Housing 41

The inner housing 41 includes, for example, a base portion 42 and one or more (two in this embodiment) terminal accommodating portions 44 extending in the first direction X1 from the base portion 42. The inner housing 41 is, for example, made of synthetic resin. The inner housing 41 is, for example, a component separate from the shield shell 50. The inner housing 41 is, for example, accommodated in the shield shell 50. The inner housing 41 is, for example, inserted into the shield shell 50 along the first opposite direction X2.

The base portion 42 is provided on an end part in the first opposite direction X2 of the inner housing 41. The base portion 42 includes two accommodation tubes 43. As shown in FIG. 4, end parts in the axial direction of the two shielded wires 20 are, for example, individually accommodated in the two accommodation tubes 43. The wire connecting portion 71 of the shield sleeve 70 and the fixing member 75 mounted on the outer periphery of the wire connecting portion 71 are, for example, accommodated in each accommodation tube 43.

The two terminals 31 are, for example, individually accommodated in the two accommodation tubes 44. Each terminal accommodating portion 44 is, for example, formed into a tubular shape extending in the first direction X1 from the base portion 42. Internal spaces of the two terminal accommodating portions 44 respectively communicate with those of the two accommodation tubes 43. A connected part of the wire connecting portion 32 and the core wire 21 and the terminal connecting portion 33 are accommodated in each terminal accommodating portion 44. The leaf spring 80 is accommodated in each terminal accommodating portion 44. The terminal 201 of the connector 200 is inserted into the terminal accommodating portion 44. The terminal connecting portion 33 and the terminal 201 are sandwiched by the leaf spring 80 inside the terminal accommodating portion 44.

A sealing member 45 is, for example, mounted on the outer peripheral surface of the base portion 42. The sealing member 45 is, for example, formed into an annular shape continuous over the entire periphery of the base portion 42 in the circumferential direction. The sealing member 45 seals between the outer peripheral surface of the base portion 42 and the inner peripheral surface of the shield shell 50.

A sealing member 46 is, for example, mounted on the outer peripheral surfaces of the terminal accommodating portions 44. The sealing member 46 is, for example, formed into an annular shape continuous over the entire peripheries of the terminal accommodating portions 44 in the circumferential direction. The sealing member 46 seals between the outer peripheral surfaces of the terminal accommodating portions 44 and the inner peripheral surface of the connector housing 202 (see FIG. 1) of the connector 200. The sealing members 45, 46 are, for example, made of rubber.

### Configuration of Shield Shell 50

The shield shell 50 surrounds the outer periphery of the inner housing 41. The shield shell 50 is, for example, formed into a tubular shape as a whole. The shield shell 50 is, for example, open in the first direction X1 and open in the first opposite direction X2. The shield shell 50 is, for example, made of metal. A copper-based, aluminum-based or iron-based metal material can be, for example, used as a material of the shield shell 50. The shield shell 50 of this embodiment is made of aluminum die cast.

The shield shell 50 includes an accommodating portion 51 for accommodating the inner housing 41 and a wire accommodating portion 60 for accommodating the shielded wires 20 exposed from the inner housing 41. The shield shell 50 is, for example, a single component in which the accommodating portion 51 and the wire accommodating portion 60 are continuously and integrally formed.

The accommodating portion 51 is, for example, provided further in the first direction X1 than the wire accommodating portion 60. The accommodating portion 51 is formed into a tubular shape. An internal space of the accommodating portion 51 is, for example, formed in a size capable of accommodating the entire inner housing 41. The accommodating portion 51 is, for example, so formed that an inner peripheral dimension thereof becomes larger from the wire accommodating portion 60 toward an end part in the first direction X1.

The wire accommodating portion 60 is provided in an end part in the first opposite direction X2 of the shield shell 50. The wire accommodating portion 60 is formed into a tubular shape. An internal space of the wire accommodating portion 60 is, for example, smaller than that of the accommodating portion 51. An inner peripheral dimension of an end part in the first direction X1 of the wire accommodating portion 60 is, for example, smaller than that of an end part in the first opposite direction X2 of the accommodating portion 51. The inner peripheral dimension of an end part in the first direction X1 of the wire accommodating portion 60 is, for example, formed in such a size that the inner housing 41 is not insertable.

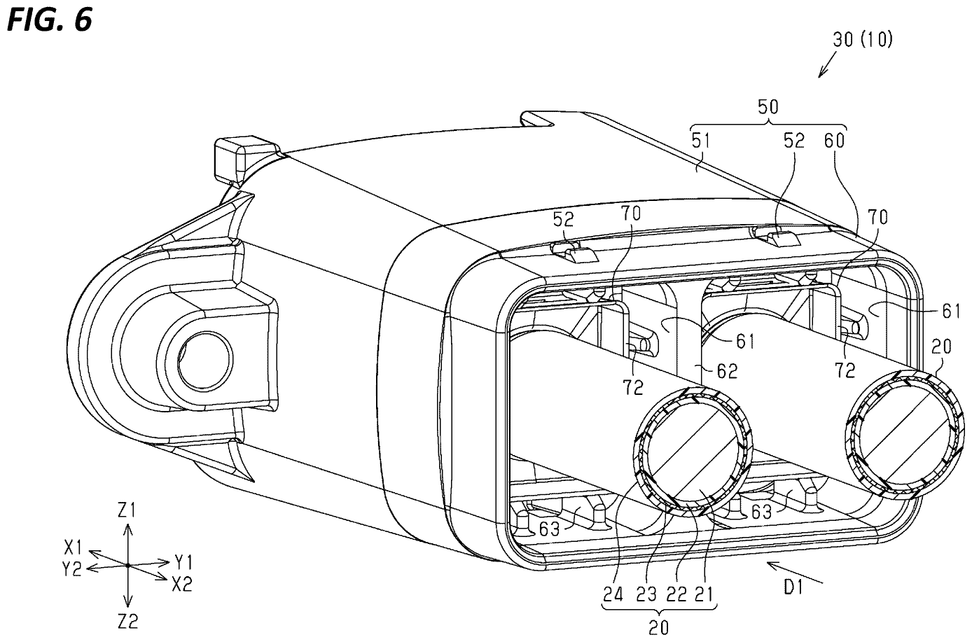

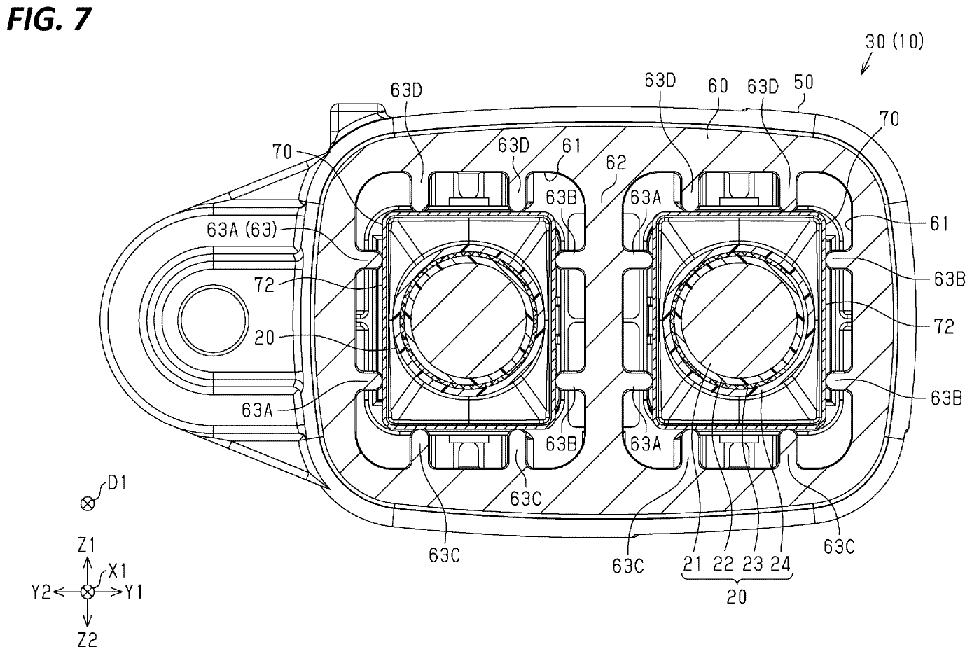

As shown in FIGS. 6 and 7, the wire accommodating portion 60 includes, for example, two through holes 61, through which the two shielded wires 20 are individually passed. Each through hole 61 penetrates through the wire accommodating portion 60 in the first direction X1. A planar shape of each through hole 61 when viewed from a penetration direction (here, the first direction X1) of the through hole 61 can be an arbitrary shape. The planar shape of each through hole 61 when viewed from the first direction X1 can be, for example, a circular shape, a polygonal shape, a square shape or a flat shape. As shown in FIG. 7, a planar shape of each through hole 61 when viewed from the press-fitting direction D1 (here, the first direction X1) is, for example, a shape along the outer peripheral surface of the press-fit portion 72 of the shield sleeve 70. The planar shape of each through hole 61 when viewed from the press-fitting direction D1 of this embodiment is a rectangular shape. Note that the sealing members 90, the restricting member 100 and the retainer 110 shown in FIG. 2 are not shown in FIG. 6.

The wire accommodating portion 60 includes a partition wall 62 partitioning the two through holes 61. The partition wall 62 is provided between the two through holes 61 in the second direction Y1. The partition wall 62 extends, for example, along the first direction X1. The partition wall 62 constitutes parts of the inner peripheral surfaces of the two through holes 61.

The wire accommodating portion 60 includes a plurality of projecting portions 63 provided on the inner peripheral surface of each through hole 61. That is, in the wire accommodating portion 60, a plurality of (here, eight) projecting portions 63 are provided on the inner peripheral surface of each of the two through holes 61. Each projecting portion 63 projects radially inwardly of the through hole 61 from the inner peripheral surface of the through hole 61. The tip surface of each projecting portion 63 is in contact with the outer peripheral surface of the press-fit portion 72 of the shield sleeve 70. In the wire accommodating portion 60, all the tip surfaces of the eight projecting portions 63 are in contact with the outer peripheral surface of the press-fit portion 72. Here, the projecting portion 72 is press-fit in contact with the eight projecting portions 63. That is, out of the wire accommodating portion 60, a part provided with the projecting portions 63 is a part, into which the press-fit portions 72 are press-fit.

The eight projecting portions 63 are provided at intervals along a circumferential direction of each through hole 61. For example, two projecting portions 63 are provided on the inner peripheral surface of each side of the rectangular through hole 61. The eight projecting portions 63 include two projecting portions 63A projecting in the second direction Y1 and two projecting portions 63B projecting in the second opposite direction Y2. The eight projecting portions 63 include two projecting portions 63C projecting in the third direction Z1 and two projecting portions 63D projecting in the third opposite direction Z2. The two projecting portions 63A are, for example, provided to respectively face the two projecting portions 63B in the second direction Y1. The two projecting portions 63C are, for example, provided to respectively face the two projecting portions 63D in the third direction Z1.

Out of each through hole 61, a space inside the tip surfaces of the eight projecting portions 63 is smaller than the outer peripheral dimension of the press-fit portion 72 of the shield sleeve 70. A shortest distance between the tip surfaces of the projecting portions 63A and those of the projecting portions 63B is, for example, smaller than a length of the projecting portion 72 along the second direction Y1. A shortest distance between the tip surfaces of the projecting portions 63C and those of the projecting portions 63D is, for example, smaller than a length of the projecting portion 72 along the third direction Z1.

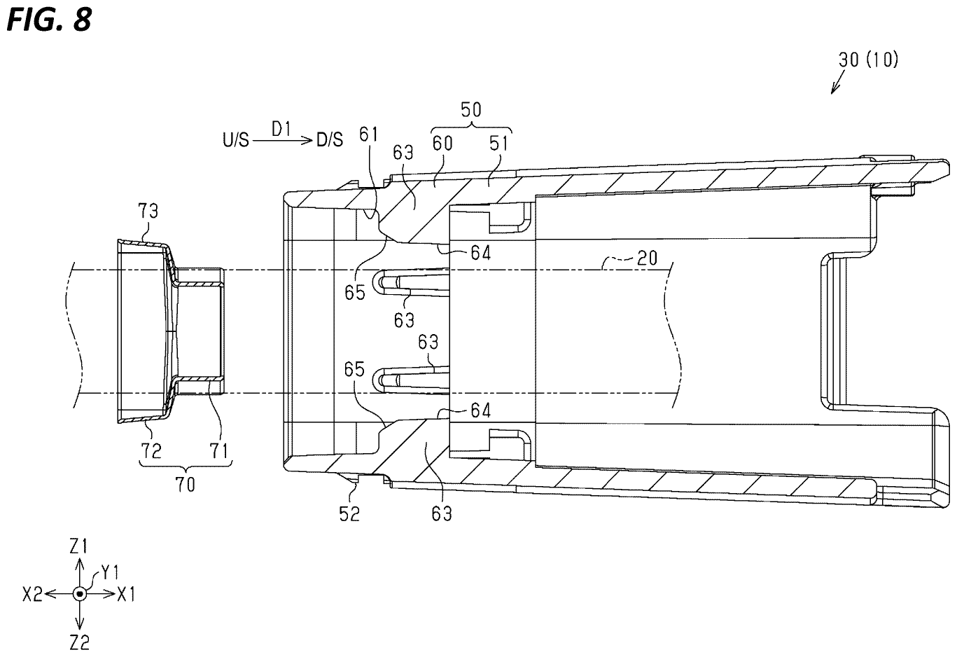

As shown in FIG. 8, each projecting portion 63 extends along the press-fitting direction D1 of the shield sleeve 70 into the shield sleeve 50. Here, the press-fitting direction D1 is along an axial direction of the through hole 61. Each projecting portion 63 is, for example, provided on the end part in the first direction X1 of the wire accommodating portion 60. Each projecting portion 63 extends, for example, in the first opposite direction X2 from the end part in the first direction X1 of the wire accommodating portion 60. Each projecting portion 63 is, for example, formed to have a width reduced from the end part in the first direction X1 toward the end part in the first opposite direction X2 of the wire accommodating portion 60. Note that, out of the connector 30, only the shield shell 50 and the shield sleeve 70 are shown in a disassembled state in FIG. 8.

The tip surface of each projecting portion 63 has, for example, a second inclined surface 64 and a guiding surface 65. The guiding surface 65 is provided on an end part in the first opposite direction X2 of the projecting portion 63. The second inclined surface 64 is inclined radially outwardly of the shield shell 50 from the end part in the first direction X1 of the projecting portion 63 toward the guiding surface 65. In other words, the second inclined surface 64 is inclined radially inwardly of the through hole 61 from the upstream side in the press-fitting direction D1 toward the downstream side in the press-fitting direction D1 of the shield sleeve 70 into the shield shell 50. In this way, an internal space surrounded by the plurality of projecting portions 63, out of the through hole 61, is formed to become smaller toward the downstream side in the press-fitting direction D1 of the shield sleeve 70.

The guiding surface 65 is formed to guide the shield sleeve 70 to the downstream side in the press-fitting direction D1. The guiding surface 65 is inclined radially outwardly of the shield shell 50 from the second inclined surface 64 toward the end part in the first opposite direction X2 of the projecting portion 63. In other words, the guiding surface 65 is inclined radially inwardly of the through hole 61 from the upstream side in the press-fitting direction D1 toward the downstream side in the press-fitting direction D1. The guiding surface 65 is, for example, inclined more than the second inclined surface 64 with respect to the press-fitting direction D1. For example, an angle between a plane parallel to the press-fitting direction D1 and the guiding surface 65 is larger than an angle between a plane parallel to the press-fitting direction D1 and the second inclined surface 64.

As shown in FIG. 7, the tip surface of each projecting portion 63 is formed to have a round cross-sectional shape obtained by cutting the projecting portion 63 by a plane perpendicular to the press-fitting direction D1. That is, the tip surface of each projecting portion 63 is formed to have a round cross-sectional shape cut to divide the projecting portion 63 in the press-fitting direction D1. In other words, the cross-sectional shape of the tip surface of each projecting portion 63 cut to divide the projecting portion 63 in the press-fitting direction D1 is formed to have a curved shape having no corner. In other words, a transverse cross-sectional shape along the tip surface of each projecting portion 63 is a round shape.

As shown in FIG. 6, the shield sleeve 70 mounted on the outer periphery of each shielded wire 20 is press-fit into each through hole 61 of the wire accommodating portion 60. Specifically, the press-fit portion 72 of the shield sleeve 70 fixed to the outer periphery of each shielded wire 20 is press-fit into the internal space inside the plurality of projecting portions 63, out of each through hole 61. At this time, in each through hole 61, the tip surfaces of all the eight projecting portions 63 are in contact with the outer peripheral surface of the press-fit portion 72. In this way, the shield shell 50 is electrically and mechanically connected to the shield sleeve 70. Further, the shield sleeve 70 press-fit into each through hole 61 is held in the shield shell 50. Thus, the shielded wire 20 fixed to the shield sleeve 70 is held in the shield shell 50.

The outer peripheral surface of the shield shell 50 includes one or more (four in this embodiment) engaging portions 52. Each engaging portion 52 is provided on the outer peripheral surface of the shield shell 50 in the end part in the first opposite direction X2. Each engaging portion 52 is, for example, provided on the outer peripheral surface of the wire accommodating portion 60. Each engaging portion 52 is formed to project radially outwardly of the shield shell 50 from the outer peripheral surface of the shield shell 50.

### Configuration of Sealing Members 90

As shown in FIG. 4, the two sealing members 90 are respectively mounted on the two shielded wires 20. Each sealing member 90 is mounted on the outer peripheral surface of the sheath 24 of each shielded wire 20. Each sealing member 90 is provided further in the first opposite direction X2 than the shield sleeve 70. The two sealing members 90 are individually fit inside the two through holes 61. Each sealing member 90 is formed into an annular shape having an outer peripheral surface along the inner peripheral surface of the through hole 61. Each sealing member 90 includes a through hole 91, through which the shielded wire 20 is passed. The inner peripheral surface of the through hole 91 is shaped along the outer peripheral surface of the shielded wire 20. Each sealing member 90 is configured to be resiliently deformable. Each sealing member 90 is held in close contact with the outer peripheral surface of the shielded wire 20 and held in close contact with the inner peripheral surface of the through hole 61. Each sealing member 90 seals between the outer peripheral surface of the shielded wire 20 and the inner peripheral surface of the shield shell 50. Note that each sealing member 90 is, for example, made of rubber.

### Configuration of Restricting Member 100

The restricting member 100 is, for example, mounted on the outer peripheries of the two shielded wires 20. The restricting member 100 is mounted on the outer peripheral surfaces of the sheaths 24 of the two shielded wires 20. The restricting member 100 is provided further in the first opposite direction X2 than the sealing members 90. The restricting member 100 is accommodated inside the shield shell 50.

### Configuration of Retainer 110

As shown in FIG. 3, the retainer 110 is, for example, mounted on an end part in the first opposite direction X2 of the shield shell 50. The retainer 110 prevents the sealing members 90 and the restricting member 100 from coming out from the shield shell 50. The retainer 110 includes a body portion 111 and coupling portions 112 projecting in the first direction X1 from the body portion 111. The body portion 111 is provided to close an opening in the first opposite direction X2 of the shield shell 50. The body portion 111 includes two wire through holes 111X, through which the two shielded wires 20 are individually passed. Each wire through hole 111X penetrates through the body portion 111 in the first direction X1. The coupling portion 112 is provided to cover a part of the outer peripheral surface of the shield shell 50. The coupling portion 112 includes an engaging portion 113 to be engaged with the engaging portion 52 of the shield shell 50. The retainer 110 is mounted on the shield shell 50 by engaging the engaging portions 113 of the retainer 110 and the engaging portions 52 of the shield shell 50 with each other.

Note that each shielded wire 20 is pulled out to the outside of the shield shell 50 in the first opposite direction X2 through the sealing member 90, the restricting member 100 and the retainer 110.

### Manufacturing Method of Wiring Harness 10

Next, an example of a manufacturing method of the wiring harness 10 is described.

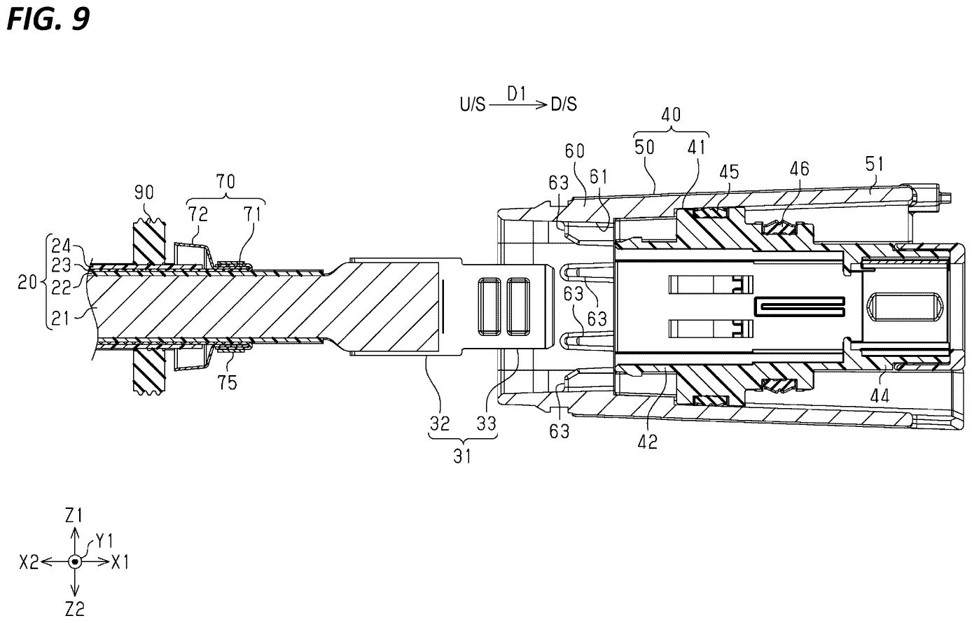

First, as shown in FIG. 9, the shield sleeves 70 are individually mounted on the plurality of shielded wires 20. Specifically, the wire connecting portion 71 of the shield sleeve 70 is fixed to the outer peripheral surface of the shielded wire 20 by the fixing member 75 while being held in contact with the outer periphery of the electromagnetic shield member 23. Subsequently, the sealing members 90 are individually mounted on the plurality of shielded wires 20. Further, in this process, the inner housing 41 and the shield shell 50 are prepared and the inner housing 41 is accommodated into the accommodating portion 51 of the shield shell 50.

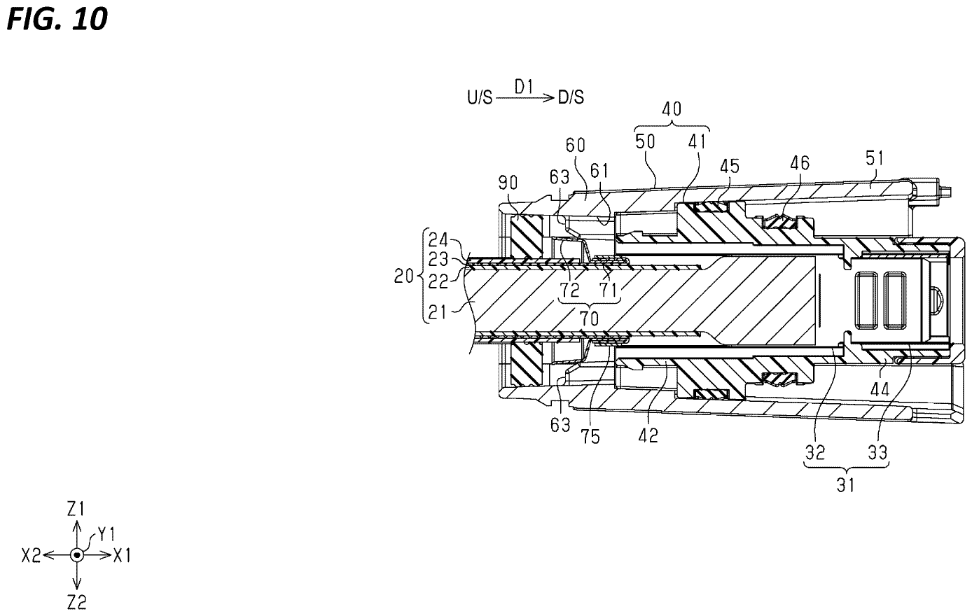

Subsequently, as shown in FIG. 10, the shielded wire 20 having the shield sleeve 70 and the sealing member 90 mounted thereon is inserted into the shield shell 50 along the press-fitting direction D1. In FIG. 10, the press-fitting of the press-fit portion 72 of the shield sleeve 70 into the through hole 61 of the shield shell 50 is started. Here, the outer peripheral dimension of the press-fit portion 72 before press-fitting is larger than the space provided inside the tip surfaces of the plurality of projecting portions 63, out of the through hole 61.

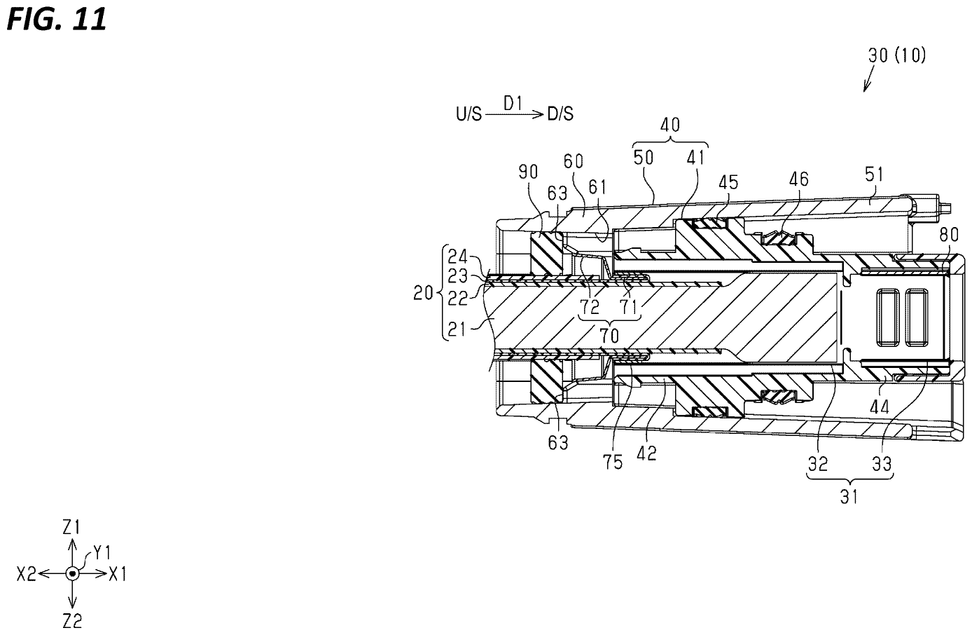

Subsequently, as shown in FIG. 11, the press-fit portion 72 of the shield sleeve 70 is press-fit into the through hole 61 if the shield sleeve 70 is further inserted into the through hole 61 along the press-fitting direction D1. At this time, the press-fit portion 72 is pressed radially inward by the plurality of projecting portions 63 provided on the inner peripheral surface of the through hole 61. In this way, the press-fit portion 72 is press-fit into the through hole 61 while undergoing deformation such as a diameter reduction. At this time, the inner peripheral surface of the through hole 61 is formed with regions, where the projecting portions 63 are not provided, in the circumferential direction of the through hole 61. Thus, the deformation of the projecting portion 72 can be released into such regions where the projecting portions 63 are not provided. As a result, the press-fit portion 72 can be suitably press-fit while being deformed.

Thereafter, the restricting member 100 and the retainer 110 shown in FIG. 3 are mounted on the shield shell 50, whereby the wiring harness 10 can be manufactured.

Next, functions and effects of this embodiment are described.
(1) The connector 30 is provided with the electrically conductive terminals 31 to be connected to the end parts of the core wires 21 of the shielded wire 20. The connector 30 is provided with the electrically conductive shield sleeves 70 to be mounted on the outer peripheries of the shielded wires 20 while being held in contact with the outer peripheries of the electromagnetic shield members 23 of the shielded wires 20. The connector 30 is provided with the electrically conductive shield shell 50 for covering the terminals 31 and the shield sleeves 70. The shield shell 50 includes the through holes 61, through which the shielded wires 20 are passed. The shield sleeve 70 includes the press-fit portion 72 to be press-fit into the through hole 61 along the direction extending parallel to the axial direction of the through hole 61. The press-fit portion 72 is press-fit in contact with the shield shell 50.

According to this configuration, the shield sleeve 70 is held in contact with the outer periphery of the electromagnetic shield member 23 and the press-fit portion 72 thereof is press-fit in contact with the shield shell 50. In this way, the shield sleeve 70 and the electromagnetic shield member 23 are electrically connected to each other, and the shield sleeve 70 and the shield shell 50 are electrically connected to each other. Further, since the connected part of the shield sleeve 70 and the shield shell 50 can have a press-fit structure, the shield sleeve 70 and the shield shell 50 can be firmly connected as compared to the case where the shield sleeve 70 and the shield shell 50 are connected by a spring. In this way, the shield sleeve 70 can be firmly held in the shield shell 50 and the shielded wire 20 can be firmly held in the shield shell 50. Thus, even if the shielded wire 20 vibrates due to vehicle travel or the like, a movement (e.g. swing) of the shielded wire 20 can be suitably restricted in the connected part of the shield sleeve 70 and the shield shell 50. As a result, the wear of the connected part of the shield sleeve 70 and the shield shell 50 can be suppressed and a reduction in electromagnetic shielding performance can be suppressed.
(2) Further, since a movement of the shielded wire 20 can be restricted in the connected part of the shield sleeve 70 and the shield shell 50 even if the shielded wire 20 vibrates, the transmission of vibration to the terminal 31 provided further in the first direction X1 than that connected part can be suppressed. In this way, it can be suitably suppressed that a contact point between the terminals 31 and 201 is worn due to the vibration of the shielded wire 20.
(3) The first inclined surface 73 inclined radially inwardly of the through hole 61 from the upstream side in the press-fitting direction D1 toward the downstream side in the press-fitting direction D1 is provided on the outer peripheral surface of the press-fit portion 72. Thus, the press-fit portion 72 is so formed that the outer peripheral dimension thereof becomes smaller from the upstream side in the press-fitting direction D1 toward the downstream side in the press-fitting direction D1. Therefore, the press-fit portion 72 has various outer peripheral dimensions. In this way, dimensional tolerances of the shield sleeve 70 and the shield shell 50 can be suitably absorbed by the first inclined surface 73. As a result, even if the dimensional tolerances of the shield sleeve 70 and the shield shell 50 are large, the press-fit portion 72 can be suitably press-fit into the through hole 61.
(4) The plurality of projecting portions 63 to be brought into contact with the press-fit portion 72 of the shield sleeve 70 in a press-fit state are provided at intervals along the circumferential direction of the through hole 61. In other words, there are regions, where wall portions, i.e. the projecting portions 63 to be brought into contact with the press-fit portion 72 in the press-fit state are not provided, in circumferential parts of the through hole 61 on the inner peripheral surface of the through hole 61. By providing such regions, even if the press-fit portion 72 is deformed when being press-fit into the through hole 61, the deformation of the press-fit portion 72 can be suitably released to the above regions. Since the deformation of the press-fit portion 72 can be allowed during press-fitting in this way, the assemblability of the shield sleeve 70 and the shield shell 50 in press-fitting the press-fit portion 72 into the through hole 61 can be improved.
(5) The second inclined surface 64 inclined radially inwardly of the through hole 61 from the upstream side in the press-fitting direction D1 toward the downstream side in the press-fitting direction D1 is provided on the tip surface of each projecting portion 63. Thus, the space provided inside the plurality of projecting portions 63, out of the through hole 61, is formed to become smaller from the upstream side in the press-fitting direction D1 toward the downstream side in the press-fitting direction D1. In this way, the dimensional tolerances of the shield sleeve 70 and the shield shell 50 can be suitably absorbed by the second inclined surfaces 64. Therefore, even if the dimensional tolerances of the shield sleeve 70 and the shield shell 50 are large, the press-fit portion 72 can be suitably press-fit into the through hole 61.
(6) The guiding surface 65 inclined more radially inwardly of the through hole 61 than the second inclined surface 64 from the upstream side in the press-fitting direction D1 toward the downstream side in the press-fitting direction D1 is provided on the tip surface of the projecting portion 63. According to this configuration, when being press-fit into the through hole 61, the press-fit portion 72 is guided to the downstream side in the press-fitting direction D1 along the guiding surfaces 65 of the projecting portions 63. In this way, workability in press-fitting the press-fit portion 72 into the through hole 61 can be improved.
(7) Since the tip surfaces of the projecting portions 63 are formed to have a round shape, the shield sleeve 70 is less likely to be damaged, for example, as compared to the case where the tip surfaces of the projecting portions 63 have an angular shape.
(8) The press-fit portion 72 is in the form of a rectangular tube. The through hole 61 is formed to have a rectangular planar shape when viewed from the press-fitting direction D1. According to this configuration, if the press-fit portion 72 is press-fit into the through hole 61, the relative rotation of the press-fit portion 72 about an axis extending in the press-fitting direction D1 with respect to the through hole 61 can be suitably suppressed. In this way, the relative rotation of the shielded wire 20 about the axis extending in the press-fitting direction D1 with respect to the through hole 61 can be suppressed.
(9) The press-fit portion 72 to be press-fit into the through hole 61 is so formed that the outer peripheral dimension thereof is larger than that of the wire connecting portion 71 to be connected to the outer periphery of the electromagnetic shield member 23. In this way, even if the press-fit portion 72 is deformed by being press-fit into the through hole 61, the damage of the electromagnetic shield member 23 due to that deformation of the press-fit portion 72 can be suitably suppressed.
(10) The shield shell 50 is made of aluminum die cast. According to this configuration, the electrically conductive shield shell 50 can be easily manufactured.

### Other Embodiments

The above embodiment can be modified and carried out as follows. The above embodiment and the following modifications can be carried out in combination without technically contradicting each other.
The structure of the shield shell 70 in the above embodiment can be changed as appropriate.
Although the press-fit portion 72 is provided on the end part in the first opposite direction X2 of the shield sleeve 70 in the above embodiment, there is no limitation to this. For example, the press-fit portion 72 may be provided on the end part in the first direction X1 of the shield sleeve 70. In this case, the wire connecting portion 71 is, for example, provided further in the first opposite direction X2 than the press-fit portion 72.
Although the press-fit portion 72 is in the form of a rectangular tube in the above embodiment, there is no limitation to this. For example, the press-fit portion 72 may be formed into a hollow cylindrical shape.
Although the first inclined surface 73 is provided on the outer peripheral surface of the press-fit portion 72 in the above embodiment, there is no limitation to this. For example, the press-fit portion 72 may be so formed that the outer peripheral dimension thereof is constant over the entire length in the axial direction of the press-fit portion 72.
The structure of the shield shell 50 in the above embodiment can be changed as appropriate. For example, if the shield shell 50 is structured to cover the terminals 31 and includes the through holes 61, into which the press-fit portions 72 of the shield sleeves 70 are press-fit, the other structure is not particularly limited. For example, the number of the projecting portions 63 is not particularly limited. For example, one projecting portion 63 may be provided on the inner peripheral surface constituting each side of the rectangular through hole 61. For example, three projecting portions 63 may be provided on the inner peripheral surface constituting each side of the rectangular through hole 61.
Although the projecting portions 63 are provided at intervals along the circumferential direction of the through hole 61 in the above embodiment, there is no limitation to this. For example, one projecting portion 63 may be continuously formed over the entire periphery of the through hole 61 in the circumferential direction.
The shield shell 50 in the above embodiment is limited to the one made of aluminum die cast. For example, the shield shell 50 may be formed by a processing method such as cutting.
If the inner housing 41 of the above embodiment is structured to be able to accommodate the terminals 31, the other structure is not particularly limited. For example, the inner housing 41 may be made of a copper-based, aluminum-based or iron-based metal material.
The sealing members 90 of the above embodiment may be omitted.
The restricting member 100 of the above embodiment may be omitted.
The retainer 110 of the above embodiment may be omitted.
The structure of the terminal 31 of the above embodiment may be changed as appropriate.
The structure of the shielded wire 20 of the above embodiment may be changed as appropriate.
The sheath 24 in the shielded wire 20 of the above embodiment may be omitted.
The number of the terminals 31 provided in the connector 30 of the above embodiment is not limited to two. For example, the number of the terminals 31 of the connector 30 may be one, three or more. Note that the number of the shielded wires 20 can be changed as appropriate according to that of the terminals 31.
The wire connecting portion 71 of each shield sleeve 70 of the shown embodiment may be referred to as a small-diameter tube portion, which may directly contact the radially outward facing surface of the electromagnetic shield member 23 of the corresponding shielded wire 20, but may not directly contact the radially inward facing surface of the through hole 61 of the wire accommodating portion 60. The press-fit portion 72 of each shield sleeve 70 of the shown embodiment may be referred to as a large-diameter tube portion, which may directly contact the radially inward facing surface of the through hole 61 of the wire accommodating portion 60, but may not directly contact the radially outward facing surface of the corresponding shielded wire 20. As in the shown embodiment, the shield sleeve 70 may include a step in the radial direction between the wire connecting portion 71 and the press-fit portion 72 or a slope continuously coupling the wire connecting portion 71 and the press-fit portion 72. One or more projecting portions 63 of each through hole 61 of the above embodiment may be referred to as non-resilient projecting portion(s) or tooth portion(s), for example, configured to rigidly contact the radially outward facing surface of the press-fit portion 72 of the corresponding shield sleeve 70. The second inclined surface 64 of each projecting portion 63 of each through hole 61 of the above embodiment may be referred to as a frictional contact surface configured to frictionally contact a local position of the radially outward facing surface of the press-fit portion 72 of the corresponding shield sleeve 70.
The embodiment disclosed this time should be considered illustrative in all aspects, rather than restrictive. The scope of the present invention is represented not by the above meaning, but by claims and is intended to include all changes in the scope of claims and in the meaning and scope of equivalents.

### LIST OF REFERENCE NUMERALS

C1 connector assembly
D1 press-fitting direction
10 wiring harness
20 shielded wire
21 core wire
22 insulation coating
23 electromagnetic shield member
24 sheath
30 connector
31 terminal
32 wire connecting portion
33 terminal connecting portion
40 connector housing
41 inner housing
42 base portion
43 accommodation tube
44 terminal accommodating portion
45,46 sealing member
50 shield shell
51 accommodating portion
52 engaging portion
60 wire accommodating portion
61 through hole
62 partition wall
63, 63A, 63B, 63C, 63D projecting portion
64 second inclined surface
65 guiding surface
70 shield sleeve
71 wire connecting portion
72 press-fit portion
73 first inclined surface
75 fixing member
80 leaf spring
90 sealing member
91 through hole
100 restricting member
110 retainer
111 body portion
111X wire through hole
112 coupling portion
113 engaging portion
200 connector
201 terminal
202 connector housing
210 case

1. A connector to be connected to an end part of a shielded wire including an electrically conductive core wire, an insulation coating surrounding an outer periphery of the core wire and an electrically conductive electromagnetic shield member surrounding an outer periphery of the insulation coating, comprising:
an electrically conductive terminal to be connected to the core wire;
an electrically conductive shield sleeve to be mounted on an outer periphery of the shielded wire while being held in contact with an outer periphery of the electromagnetic shield member; and
an electrically conductive shield shell for covering the terminal and the shield shell,
the shield shell including a through hole, the shielded wire being passed through the through hole,
the shield sleeve including a press-fit portion to be press-fit into the through hole along a press-fitting direction extending parallel to an axial direction of the through hole, and
the press-fit portion being press-fit in contact with the shield shell.

2. The connector of claim 1, wherein an outer peripheral surface of the press-fit portion has a first inclined surface inclined radially inwardly of the through hole from an upstream side in the press-fitting direction toward a downstream side in the press-fitting direction.

3. The connector of claim 1, wherein:
a plurality of projecting portions projecting radially inwardly of the through hole are provided on an inner peripheral surface of the through hole,
the plurality of projecting portions are provided at intervals along a circumferential direction of the through hole, and
the press-fit portion is press-fit in contact with a tip surface of each of the plurality of projecting portions.

4. The connector of claim 3, wherein:
each of the plurality of projecting portions extends along the press-fitting direction, and
the tip surface has a second inclined surface inclined radially inwardly of the through hole from an upstream side in the press-fitting direction toward a downstream side in the press-fitting direction.

5. The connector of claim 4, wherein:
the tip surface has a guiding surface for guiding the shield sleeve to the downstream side in the press-fitting direction,
the guiding surface is inclined radially inwardly of the through hole from the upstream side in the press-fitting direction toward the downstream side in the press-fitting direction, and
the guiding surface is inclined more than the second inclined surface with respect to the press-fitting direction.

6. The connector of claim 3, wherein the tip surface is formed to have a round cross-sectional shape obtained by cutting the projecting portion by a plane perpendicular to the press-fitting direction.

7. The connector of claim 1, wherein:
the press-fit portion is in the form of a rectangular tube, and
the through hole is formed to have a rectangular planar shape when viewed from the press-fitting direction.

8. The connector of claim 1, wherein:
the shield sleeve includes the press-fit portion and a wire connecting portion continuously and integrally formed with the press-fit portion and to be connected to the electromagnetic shield member, and
an outer peripheral dimension of the press-fit portion is larger than that of the wire connecting portion.

9. The connector of claim 1, wherein the shield shell is made of aluminum die cast.

10. A wiring harness, comprising:
the connector of claim 1, and
the shielded wire to be connected to the terminal.
